(19) United States
(12) Patent Application Publication
(10) Pub. No.: US 2025/0129194 A1
(43) Pub. Date: Apr. 24, 2025

(54) DYNAMICALLY CROSSLINKED ETHYLENE BASED POLYMERS FOR RE-PROCESSIBLE POLYOLEFINS VIA REACTIVE EXTRUSION

(71) Applicant: BRASKEM AMERICA, INC., Philadelphia, PA (US)

(72) Inventors: Sarah Mitchell, Pittsburgh, PA (US); Kimberly McLoughlin, Pittsburgh, PA (US); Michelle K. Sing, Pittsburgh, PA (US); Hadi Mohammadi, Pittsburgh, PA (US)

(21) Appl. No.: 18/918,873

(22) Filed: Oct. 17, 2024

Related U.S. Application Data
(60) Provisional application No. 63/591,254, filed on Oct. 18, 2023.

(51) Int. Cl. C08F 255/02; C08F 263/04; C08J 3/20; C08J 3/24

(52) U.S. Cl. CPC C08F 255/02; C08F 263/04; C08J 3/203; C08J 3/247; C08F 2810/20; C08J 2351/06

(57) ABSTRACT

The invention relates to a crosslinked polymerized composition, comprising a crosslinker comprising a —Sₙ— moiety and having at least two polymerizable groups, wherein n is an integer of from 2 to 8, and one or more polymers. The invention also relates to methods of making a reversibly-crosslinked polymer by reacting the components of the polymerized composition via a reactive extrusion process, resulting in reversibly-crosslinked polymer having dynamic crosslinks.

### CROSS-REFERENCE TO RELATED APPLICATION

This application claims priority to U.S. Provisional Application No. 63/591,254, filed Oct. 17, 2023, which is incorporated herein by reference in its entirety.

### FIELD OF THE INVENTION

This invention generally relates to the field of preparing reversibly-crosslinked polymers for reprocessing/recycling polymers.

### BACKGROUND OF THE INVENTION

Conventional polymer networks, also known as thermosets, consist of permanent covalent crosslinks that make reprocessing and recycling these polymers impractical. Examples of conventional polymers networks produced in high pressure polymerizations are low density polyethylene (LDPE) and ethylene/VA copolymer (EVA).

Efforts have been made to incorporate inherently reversible crosslinks into a polymer network, allowing for the polymer networks to be reprocessed and recycled. However, a full recovery of crosslinks after multiple reprocessing steps is still challenging to the current technology.

There thus remains a continuous need in the art for developing novel dynamic crosslinking chemistry to obtain a reversibly-crosslinked polymer that is fully reprocessable and recyclable, while maintaining the properties of the original polymer.

### SUMMARY OF THE INVENTION

In one aspect, provided herein is a crosslinked polymer composition, comprising a crosslinked polymer, being a reaction product of a starting polymer and a crosslinker represented by Formula (I), (II), (III), (IV), or (V): R¹R²R³C—Sₙ—CR⁴R⁵R⁶ (I); R⁷—CH(X)—Sₙ—CH(Y)—R⁸ (II); R⁷-B₁-A₁-Sₙ-A₂-B₂-R⁸ (III); R¹⁵—O—Sₙ—O—R¹⁶ (IV); or (R¹⁷)(R¹⁸)—P—Sₙ—P—(R¹⁹)(R²⁰) (V). In each of these formulas, n is an integer of from 2 to 8. In Formula (I), at least one of R¹, R², and R³ comprises a C═C double bond, and at least one of R⁴, R⁵, and R⁶ comprises a C═C double bond; in Formula (II) and (III), each of R⁷ and R⁸ comprises a C═C double bond; in Formula (IV), each of R¹⁵ and R¹⁶ comprises a C═C double bond; and in Formula (V), at least one of R¹⁷ and R¹⁸ comprises a C═C double bond, and at least one of R¹⁹ and R²⁰ comprises a C═C double bond. The polymer may be derived from an olefin monomer, such asethylene, propylene, 1-butylene, 1-pentene, 1-hexene, 1-heptene, 1-octane, 1-nonene, 1-decene, and/or a vinyl monomer, such as a vinyl acetate compound, an acrylate compound, a vinyl ester compound, a styrenic compound, a diene compound, a vinyl halide, a vinyl nitrile, a vinyl silane. The crosslinked polymer may be a reversibly-crosslinked polymer.

In another aspect, provided herein is a method of making a crosslinked polymer, comprising reacting a polymer and a crosslinker represented by Formula (I), (II), (III), (IV), or (V), as noted above. The reacting can take place by solid-state grafting, melt-state grafting, reactive extrusion, or melt mixing, of the starting polymer and the crosslinker. The method is a reactive extrusion process and takes place in the presence of a free-radical polymerization generator. The reaction may be carried out at a temperature from 70° C. to 350° C., for instance 70° C. to 200° C. The crosslinked polymer may be a reversibly-crosslinked polymer, and the method optionally includes the step of reprocessing the reversibly-crosslinked polymer at a temperature greater than 50° C., or greater than 150° C., to dissociate the crosslinking bonds. Additional aspects, advantages and features of the invention are set forth in this specification, and in part will become apparent to those skilled in the art on examination of the following, or may be learned by practice of the invention. The inventions disclosed in this application are not limited to any particular set of or combination of aspects, advantages and features. It is contemplated that various combinations of the stated aspects, advantages and features make up the inventions disclosed in this application.

### BRIEF DESCRIPTION OF THE DRAWINGS

FIG. 1 shows a schematic example of a reactive extrusion or melting mixing process leading to incorporation of a dynamic crosslinker into a polymer composition, by mixing a dynamic crosslinker and a starting polymer.

FIG. 2 shows a reaction processing scheme of a polyolefin with a dynamic disulfide crosslinker.

FIG. 3 shows A) DMA of dynamically crosslinked EVA, exploring the effect of three different dynamic disulfide crosslinkers; B) DMA of the reprocessability of samples, comparing two different dynamic disulfide crosslinkers; and C) DMA of the reprocessability of samples, comparing two different concentrations of the same crosslinker.

FIG. 4 shows A) DMA of dynamically crosslinked LDPE, exploring the effect of three different dynamic disulfide crosslinkers. B) DMA of the reprocessability of samples, comparing three different dynamic disulfide crosslinkers. C) DMA of the reprocessability of samples, base resin HDPE.

### DETAILED DESCRIPTION OF THE INVENTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and may be practiced with any other embodiment(s).

As used herein, the indefinite articles “a” and “an” can mean “one” or “at least one,” and the definite article “the” can also mean “one” or “at least one.” For example, a reference to “a crosslinker” or “the crosslinker” refers to one crosslinker or a combination of at least two crosslinkers.

The disclosure provides a crosslinked polymer composition and method for making a crosslinked polymer composition, employing a dynamic crosslinker that contains polymerizable groups allowing for its incorporation into a polymer network via solid-state grafting, melt-state grafting, reactive extrusion, or melt mixing, of the dynamic crosslinker and a starting polymer, and a reversible linkage that dissociates at an elevated temperature and reassociates when cooled down. This dynamic crosslinking produces polymer networks that are reversible and can be reprocessed and recycled.

### Crosslinked Polymer Composition

One aspect of the invention relates to a crosslinked polymer composition, comprising the reaction product of a starting polymer and a crosslinker comprising a —Sₙ— moiety and having at least two polymerizable groups, wherein n is an integer of from 2 to 8. The polymer is derived from one or more monomers, each monomer having at least one C═C double bond capable of undergoing a polymerization reaction.

The crosslinker is a dynamic crosslinker, meaning that the polymer chains of starting polymers, formed from a reaction of the crosslinkers and the starting polymer, are covalently linked via a reversible linkage provided by the crosslinker that dissociates at an elevated temperature and reassociates upon cooling. The crosslinker also contains a polymerizable group allowing for its incorporation into a polymer network of the starting polymer, via further polymerization, solid state-grafting, melt-state grafting, reactive extrusion, or melt mixing.

The crosslinker comprises a —Sₙ— moiety (n is an integer of from 2 to 8, e.g., 2 or 3) and has at least two polymerizable groups. The dynamic nature comes from the disulfide or polysulfide bond that dissociates to form a stable thiyl radical upon heating and reassociates back to reform the disulfide or polysulfide bond upon cooling down to room temperature. The polymerizable group can comprise an unsaturated bond capable of radical generation, to allow for incorporation of the crosslinker into a polymer network during further polymerization, solid state-grafting, melt-state grafting, reactive extrusion, or melt mixing polymerization reaction. For instance, the polymerizable group can comprise a C═C double bond. The two polymerizable groups may be the same or different.

The unsaturated bond (e.g., C═C double bond) capable of undergoing a radical generation is in a functional group including but not limited to an alkene, an alkyne, a nitrile, vinyl group, an acyl, an acrylate, a (meth)acrylate, (meth)acrylamide, a styrene, and a vinyl pyridine.

In some embodiments, the crosslinker may be represented by Formula (I), (II), (III), (IV), or (V):

R¹R²R³C—Sₙ—CR⁴R⁵R⁶ (I)

R⁷—CH(X)—Sₙ—CH(Y)—R⁸ (II)

R⁷-B₁-A₁-Sₙ-A₂-B₂-R⁸ (III)

R¹⁵—O—Sₙ—O—R¹⁶ (IV)

(R¹⁷)(R¹⁸)—P—Sₙ—P—(R¹⁹)(R²⁰) (V).

Integer n is from 2 to 8, such as 2 or 5, 2 to 4, or 2 to 3. Typically, n is 2 or 3. In one embodiment, n is 2. In one embodiment, n is 3.

Each of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, R¹⁸, R¹⁹, and R²⁰ is independently a hydrogen atom, a halogen atom, a C1-20 linear or branched alkyl, a C₂₋₂₀ alkenyl, a C₂₋₂₀ alkynyl, a nitrile, a hydroxyl, an ester having from 1 to 20 carbon atoms, an ether having from 1 to 20 carbon atoms, a thioether having from 1 to 20 carbon atoms, a ketone having from 1 to 20 carbon atoms, an imine, an amide, a primary amine, a secondary amine, a tertiary amine, a trifluoromethyl, a phenyl, a benzyl, a phenol, a pentafluorophenyl, a nitroxyl, or a silane having from 1 to 20 carbon atoms. Each of R¹, R², R³, R⁴, R⁵, R⁶, R⁷, R⁸, R⁹, R¹⁰, R¹¹, R¹², R¹³, and R¹⁴ can be optionally substituted by one or more alkyl, alkenyl, hydroxyl, or halide groups. The optional substituents replace the hydrogen atom(s) of these R variables. Exemplary substituents are C₁-C₆ alkyl (linear or branched), C₂-C₆ alkenyl, hydroxyl, or halide groups.

X represents CHR⁹R¹⁰, OH, SH, or NHR¹¹. Y represents CHR¹²R¹³, OH, SH, or NHR¹⁴.

Each of A₁ and A₂ is independently absent, a C₁-C₂₀ alkylene, a C₂-C₂₀ cycloalkylene, a divalent form of C₂-C₂₀ alkene, a divalent form of C₂-C₂₀ alkyne, an arylene, or combinations thereof; each optionally substituted by one or more alkyl, alkenyl, hydroxyl, or halogen atoms.

Each of B₁ and B₂ is independently absent or a divalent form of imine, amine, carbonyl, amide, ether, or ester, or combinations thereof.

The term “divalent form” refers to a divalent radical that is formed when a hydrogen atom is removed from a functional group, e.g., a radical of alkyl, alkenyl, cycloalkyl, or alkynyl, etc., or when terminal hydrogen atoms are removed from a hydrocarbon, e.g., an alkane, alkene, cycloalkane, or alkyne, etc. For instance, in the case of divalent form of alkene (alkenylene), the term refers to a divalent radical that has hydrogen atoms removed from each of the two terminal carbon atoms of the alkene chain. A divalent form of a moiety is defined to represent the moiety present in the middle of a structural formula, with each end of the moiety bonding to another moiety, bond, or hydrogen atom.

In some embodiments, the crosslinker comprises at least one crosslinker represented by Formulae (I), (II), (III), (IV), or (V). Thus, at least two crosslinkers, each being represented by Formulae (I), (II), (III), (IV), (V), may be comprised in the crosslinker.

In some embodiments, the crosslinker is represented by Formula (I). In Formula (I), at least one of R¹, R², and R³ comprises a C═C double bond and at least one of R⁴, R⁵, and R⁶ comprise a C═C double bond. R¹, R², R³, R⁴, R⁵, and R⁶ may be the same or different. (R¹R²R³) and (R⁴R⁵R⁶) may be the same or different. In some embodiments, each of R¹ and R⁴ is H; each of R² and R⁵ may be H or alkyl, and each of R³ and R⁶ comprises a C═C double bond. In some embodiments, each of R³ and R⁶ independently comprises an alkene, an alkyne, a nitrile, an acyl, an acrylate, a (meth)acrylate, (meth)acrylamide, a styrene, or a vinyl pyridine.

In some embodiments, the crosslinker is represented by Formula (II). In Formula (II), each of R⁷ and R⁸ comprises a C═C double bond. X and Y may be the same or different. R⁷ and R⁸ may be the same or different. R⁷—CH(X)— and —CH(Y)—R⁸ may be the same or different. In some embodiments, each of X and Y independent represents CHR⁹R¹⁰, OH, SH, or NHR¹¹, wherein each of R⁹, R¹⁰, and R¹¹ is independently H or alkyl. In some embodiments, each of X and Y independent represents CHR⁹R¹⁰ or NHR¹¹, wherein each of R⁹, R¹⁰, and R¹¹ is independently H or methyl. In some embodiments, each of R⁷ and R⁸ independently comprises an alkene, an alkyne, a nitrile, an acyl, an acrylate, a (meth)acrylate, (meth)acrylamide, a styrene, or a vinyl pyridine.

In some embodiments, the crosslinker is represented by Formula (III). In Formula (III), each of R⁷ and R⁸ comprises a C═C double bond. A₁ and A₂ may be the same or different. B₁ and B₂ may be the same or different. R⁷ and R⁸ may be the same or different. R⁷-B₁-A₁- and -A₂-B₂-R⁸ may be the same or different. In some embodiments, each of A₁ and A₂ is independently absent, a C₁-C₈ alkylene, a C₂-C₆ cycloalkylene, or a phenylene; each optionally substituted by one or more alkyl, hydroxyl, or halogen atoms. In some embodiments, each of B₁ and B₂ is independently absent or a divalent form of amine, amide, or ester. In some embodiments, each of R⁷ and R⁸ is independently a C₂-C₆ alkenyl, optionally substituted by one or more C₁-C₃ alkyl. In some embodiments, each of R⁷ and R⁸ is independently an unsubstituted C₂-C₆ alkenyl. In some embodiments, each of R⁷ and R⁸ is independently comprises a C₂-C₆ alkynyl optionally substituted by one or more C₁-C₃ alkyl or a nitrile.

In some embodiments, the crosslinker is represented by (III), wherein n is 2 or 3; each of R⁷ and R⁸ is independently a C₂-C₂₀ alkenyl, optionally substituted by one or more alkyl or alkenyl; each of A₁ and A₂ is independently absent, a C₁-C₂₀ alkylene or a divalent form of phenyl; each optionally substituted by one or more alkyl, alkenyl, hydroxyl, or halogen atoms; each of B₁ and B₂ is independently absent or a divalent form of amine, amide, ether, or ester.

In some embodiments, the crosslinker is represented by Formula (IV). In Formula (IV), each of R¹⁵ and R¹⁶ comprises a C═C double bond. R¹⁵—O— and —O—R¹⁶ may be the same or different. In some embodiments, each of R¹⁵ and R¹⁶ independently comprises an alkene, an alkyne, a nitrile, an acyl, an acrylate, a (meth)acrylate, (meth)acrylamide, a styrene, or a vinyl pyridine.

In some embodiments, the crosslinker is represented by Formula (V). In Formula (V), at least one of R¹⁷ and R¹⁸ comprises a C═C double bond and at least one of R¹⁹ and R²⁰ comprises a C═C double bond. R¹⁷, R¹⁸, R¹⁹, and R²⁰ may be the same or different. (R¹⁷)(R¹⁸) and (R¹⁹)(R²⁰) may be the same or different. In some embodiments, each of R¹⁷ and R¹⁹ is H or alkyl, and each of R¹⁸ and R²⁰ comprises a C═C double bond. In some embodiments, each of R¹⁸ and R²⁰ independently comprises an alkene, an alkyne, a nitrile, an acyl, an acrylate, a (meth)acrylate, (meth)acrylamide, a styrene, or a vinyl pyridine.

In some embodiments, the crosslinker has the structure of formula:

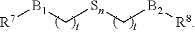

The integer n is 2 or 3. In one embodiment, n is 2. In one embodiment, n is 3. The integer t is 1 to 5, for instance 1 to 4, or 1 to 3. In one embodiment, t is 1. In one embodiment, t is 2. In one embodiment, t is 3. Each of R⁷ and R⁸ is independently a C₂-C₆ alkenyl, optionally substituted by one or more C₁-C₃ alkyl. In some embodiments, each of R⁷ and R⁸ is independently a unsubstituted C₂-C₆ alkenyl. In some embodiments, each of R⁷ and R⁸ is independently an alkene, an alkyne, a nitrile, an acyl, an acrylate, a (meth)acrylate, (meth)acrylamide, a styrene, or a vinyl pyridine, such as a C₂-C₄ alkenyl, substituted by one or more methyl. Each of B₁ and B₂ is independently absent, —O—, —OC(O)—, —C(O)O—, —C(O)—, —N(H)—, —N(H)C(O)—, or —C(O)N(H)—, or combinations thereof. In some embodiments, each of B₁ and B₂ is independently absent, —OC(O)—, —C(O)O—, —N(H)C(O)—, or —C(O)N(H)—, or combinations thereof.

In some embodiments, the crosslinker has the structure of formula:

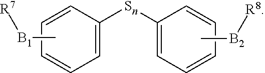

The integer n is 2 or 3. In one embodiment, n is 2. In one embodiment, n is 3. Each of R⁷ and R⁸ is independently a C₂-C₆ alkenyl, optionally substituted by one or more C₁-C₃ alkyl, or a (meth)acrylate that comprises a C═C bond. In some embodiments, each of R⁷ and R⁸ is independently a unsubstituted C₂-C₆ alkenyl. In some embodiments, each of R⁷ and R⁸ is independently a C₂-C₄ alkenyl, substituted by one or more methyl. Each of B₁ and B₂ is independently absent, —O—, —OC(O)—, —C(O)O—, —C(O)—, —N(H)—, —N(H)C(O)N(H)—, —N(H)C(O)—, —C(O)N(H)—, or any combination thereof. In some embodiments, each of B₁ and B₂ is independently —OC(O)—, —C(O)O—, —N(H)C(O)—, —C(O)N(H)—, or any combination thereof.

Exemplary crosslinkers are:

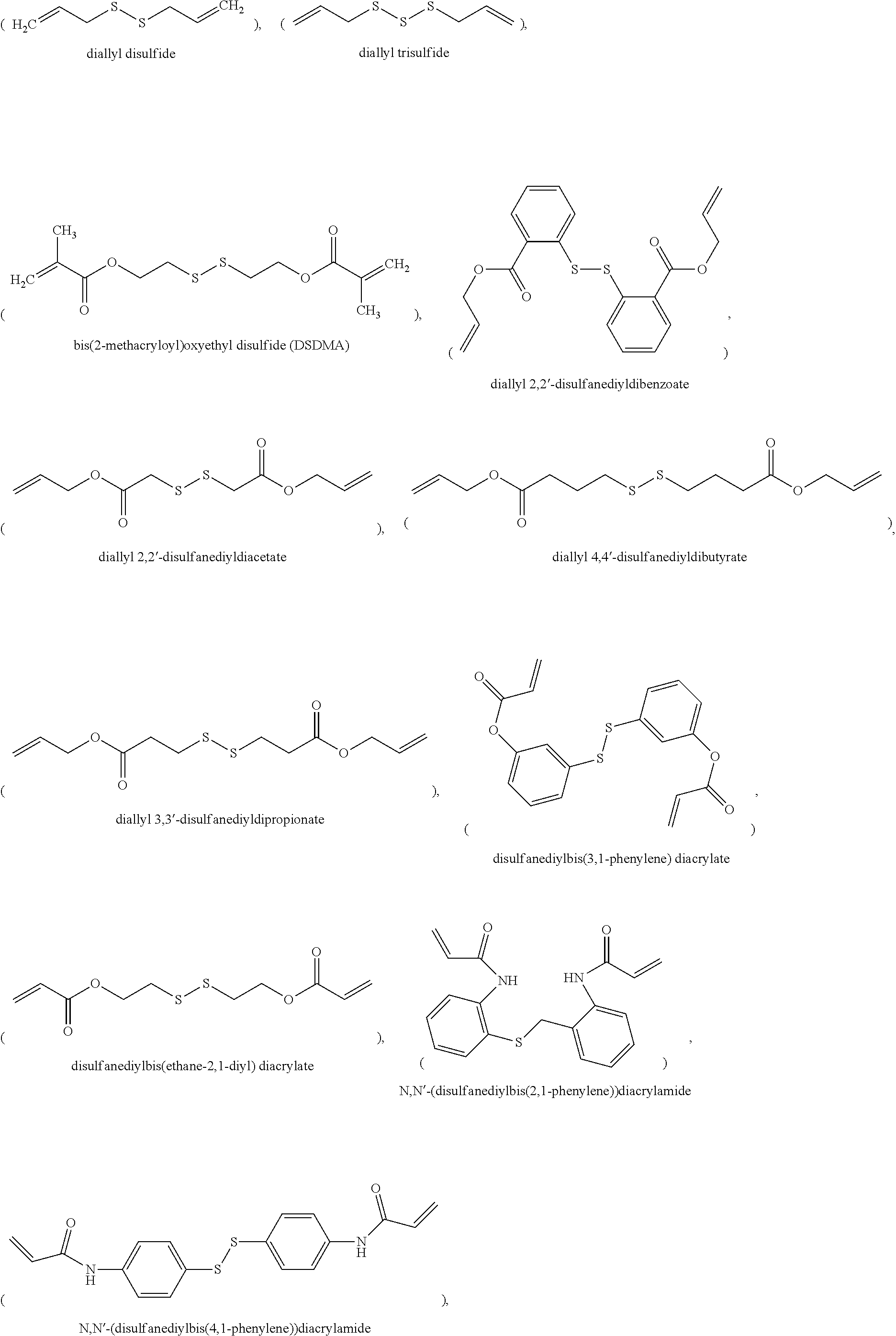

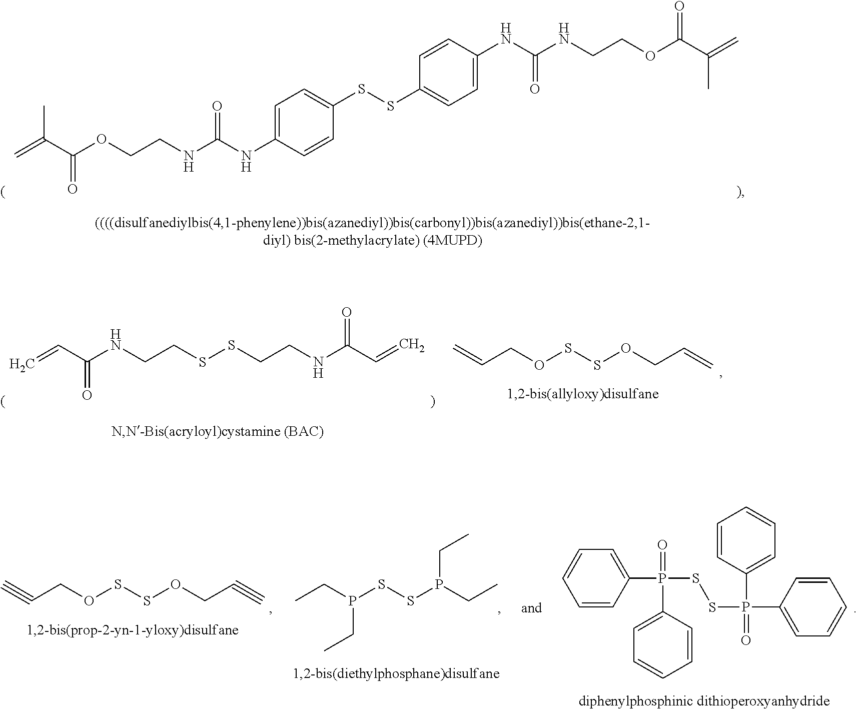

In some embodiments, the crosslinker comprises allyl disulfide, diallyl disulfide, bis(2-methacryloyl)oxyethyl disulfide, N,N′-bis(acryloyl)cystamine, ((((disulfanediylbis(4,1-phenylene))bis(azanediyl))bis(carbonyl))bis(azanediyl))bis(ethane-2,1-diyl)bis(2-methylacrylate) (4MUPD), or a combination thereof. In one embodiment, the crosslinker consists of allyl disulfide or diallyl disulfide.

In some embodiments, the crosslinker is in the form of an ensemble of crosslinker molecules, each crosslinker molecule in the ensemble being a compound represented by Formula (I), (II), (III), (IV), or (V), and wherein for at least 90% of the crosslinkers molecules in the ensemble, n is equal to 2.

In some embodiments, for at least 91%, 92%, 93%, 94%, 95%, 96%, 97%, 98%, or 99% of the crosslinkers molecules in the ensemble, n is equal to 2.

In some embodiments, the crosslinker further comprises, in addition to at least one crosslinker represented by Formula (I), (II), (III), (IV), or (V), a crosslinker represented by Formula (VI):

E₁-(R²¹)(R²²)N—Sₙ—N(R²³)(R²⁴)-E₂ (VI),

wherein each of E₁ and E₂ is independently a (meth)acrylate, (meth)acrylamide, a C₁-C₂₀ alkylene, a C₂-C₂₀ cycloalkylene, a divalent form of C₂-C₂₀ alkene, a divalent form of C₂-C₂₀ alkyne, an arylene, or combinations thereof, each optionally substituted by one or more alkyl, alkenyl, hydroxyl, or halogen atoms; wherein the crosslinker represented by Formula (VI) is in the form of an ensemble of crosslinker molecules; and wherein for at least 90% of the crosslinkers molecules represented by Formula (VI) in the ensemble, n is equal to 2. In some embodiments, for at least 91%, 92%, 93%, 94%, 95%, 96%, 97%, 98%, or 99% of the crosslinkers molecules in the ensemble, n is equal to 2.

In some embodiments, the ensemble of crosslinker molecules comprises molecules represented by Formula (VIa)

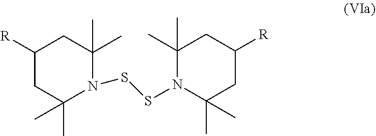

wherein, in Formula (VIa), each R represents the polymerizable group comprising the carbon-carbon double bond capable of undergoing free radical polymerization. In some embodiments, wherein crosslinkers of Formula (VIa) are comprised, the ensemble of crosslinker molecules comprises any one, or combination of, the following molecules:

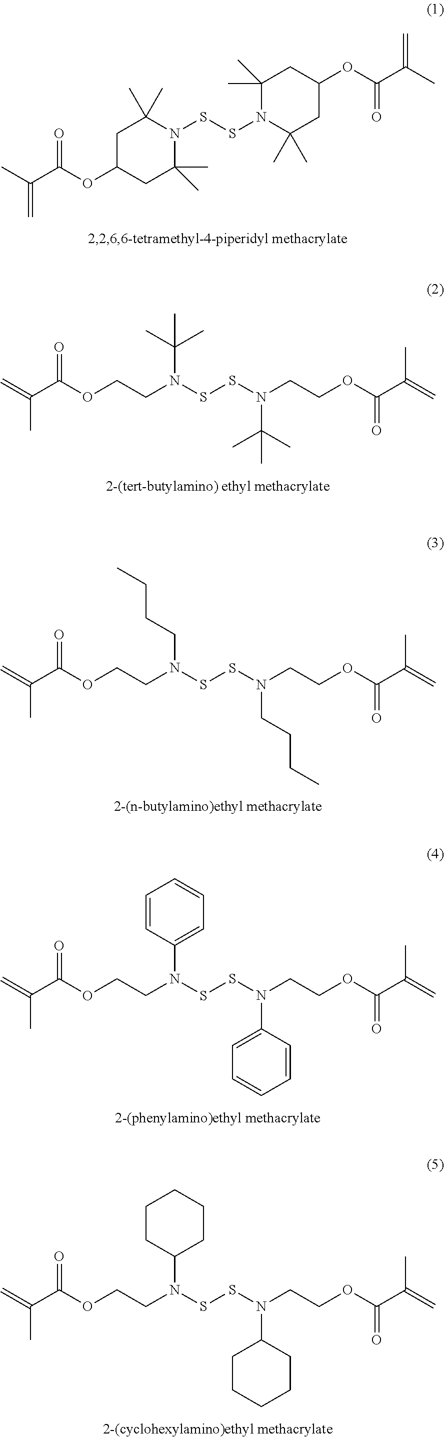

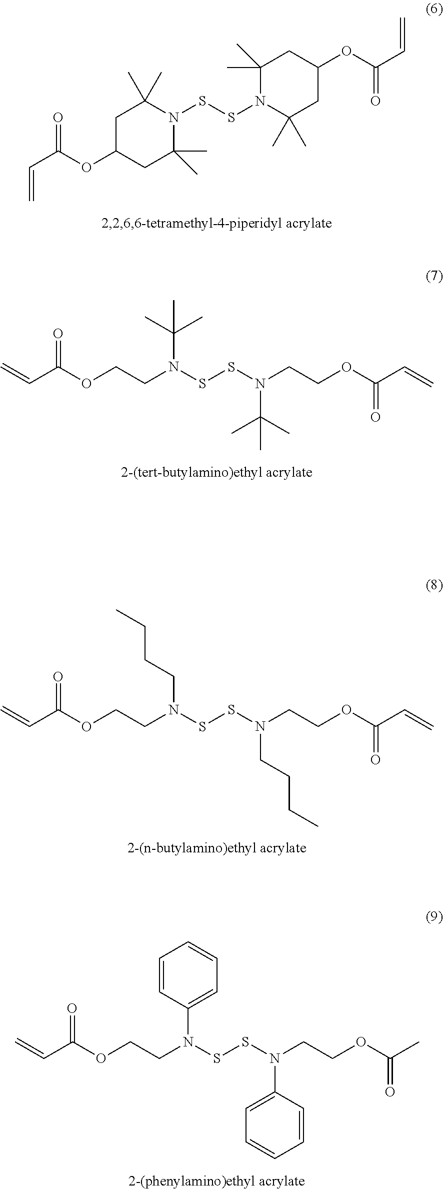

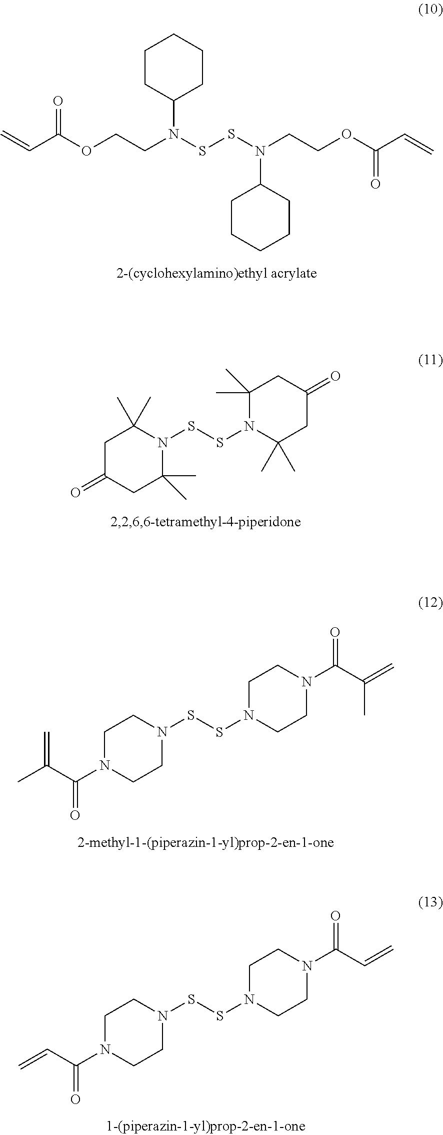

Unless indicated otherwise, the ensemble of crosslinker molecules is defined by a group, a collection, or a plurality of crosslinker molecules, each molecule functioning as a crosslinker. For example, the crosslinker bis(2,2,6,6-tetramethyl-4-piperidyl methacrylate) disulfide (“BiTEMPS”) has a N—Sₙ—N moiety within the molecule, where different, individual BiTEMP molecules can have a n value of 2, 3, 4, 5, 6, 7, or 8. In some embodiments, for at least 90% of the crosslinkers molecules in the ensemble of crosslinker molecules represented Formula (VI) or (VIa), n is equal to 2. Preferably, for at least 91%, 92%, 93%, 94%, 95%, 96%, 97%, 98%, or 99%, of the crosslinkers molecules in the ensemble, n is equal to 2. This percentage value can represent the —S₂— purity of the ensemble of crosslinker molecules. This is the case for any crosslinker molecule of the ensemble, of the present invention.

The crosslinker may be present in the crosslinked polymer composition at various amounts, for instance, in an amount ranging from 0.01 wt % to 50 wt %, from 0.05 wt % to 50 wt %, from 0.1 wt % to 50 wt %, from 0.5 wt % to 50 wt %, from 1 wt % to 50 wt %, from 5 wt % to 50 wt %, from 0.1 wt % to 40 wt %, from 0.5 wt % to 40 wt %, from 1 wt % to 40 wt %, from 5 wt % to 40 wt %, from 0.1 wt % to 30 wt %, from 0.5 wt % to 30 wt %, from 0.1 wt % to 20 wt %, from 0.5 wt % to 20 wt %, from 1 wt % to 20 wt %, from 5 wt % to 20 wt %, from 0.1 wt % to 10 wt %, from 0.5 wt % to 10 wt %, from 1 wt % to 10 wt %, or from 5 wt % to 10 wt %, relative to 100 wt % of the total amount of the polymer composition (comprising the crosslinker, polymers, and polymerization generator, if present). In terms of mol %, the crosslinker may be present in the polymer composition in an amount of at least 0.01 mol %, at least 0.05 mol %, at least 0.1 mol %, at least 0.5 mol %, at least 1 mol %, at least 2 mol %, at least 3 mol %, at least 4 mol %, at least 5 mol %, or in a range of from 0.01 mol % to 35 mol % (e.g., from 0.05 mol % to 35 mol %, from 0.1 mol % to 35 mol %, from 0.5 mol % to 35 mol %, from 1 mol % to 35 mol %, from 5 mol % to 35 mol %, from 1 mol % to 30 mol %, from 5 mol % to 30 mol %, from 1 mol % to 25 mol %, from 5 mol % to 25 mol %, from 1 mol % to 20 mol %, from 5 mol % to 20 mol %, from 1 mol % to 15 mol %, from 5 mol % to 15 mol %, from 1 mol % to 10 mol %, or from 5 mol % to 10 mol %), relative to 100 mol % of the total amount of the polymer composition (comprising the crosslinker, polymers, and polymerization generator, if present).

The starting polymer in the crosslinked polymer composition comprises reacted units of one or more monomers, which can be an olefin monomer, a vinyl monomer, or a vinyl ester monomer.

Suitable olefin monomers include a linear or branched olefins (e.g., an α-olefin) having 2 to 12 carbon atoms, 2 to 10 carbon atoms, or 2 to 8 carbon atoms. Exemplary linear or branched olefins includes, but are not limited to, ethylene, propylene, 1-butene, 2-butene, 1-pentene, 3-methyl-1-butene, 4-methyl-1-pentene, 3-methyl-1-pentene, 1-hexene, 3,5,5-trimethyl-1-hexene, 4,6-dimethyl-1-heptene, 1-octene, 1-nonene, 1-decene, 1-undecene, and 1-dodecene. These olefins may contain one or more heteroatoms such as an oxygen, nitrogen, or silicon.

In one embodiment, the olefin monomers are bio-based olefin monomers, meaning that the monomer that the polymer is based on is fully or partially derived from biological sources. As an example, polyethylene may be produced using ethylene monomers, at least some of which are produced from bio-based renewable feedstock. Suitable biological sources include 1G bioethanol, such as sugarcane, molasses, and crops (such as corn), and 2G bioethanol, such as food waste, agricultural waste, and wood waste. Through known distillation and fermentation techniques, the renewable feedstock can produce ethanol, which, through known dehydration steps, produce ethylene and ultimately polyethylene.

In another embodiment, the starting polymer comprises polymers that are obtained via polymer recycling sources, such as recycled polypropylene, recycled polyethylene, and recycled polyethylene vinyl acetate.

Thus an aspect of this invention is the sustainability aspects and/or renewable-resource aspects presented by a reversibly-crosslinked polymer that is prepared using polymers derived from bio-based olefin monomers and/or includes recycled-grade polymers, and/or is prepared using bio-based crosslinkers.

Suitable vinyl monomers can include a substituted vinyl, e.g., R^{a}R^{b}C═CR^{c}R^{d}, wherein R^{a} and R^{b} may each independently be hydrogen, halogen, alkyl, aryl (e.g., phenyl), arylalkyl (e.g., benzyl), heteroaryl (e.g., pyridinyl), alkenyl, arylalkenyl, hydroxylcarbonyl, alkoxycarbonyl, alkylaminecarbonyl, alkylcarbonyloxy, arylcarbonyloxy, or nitrile. Exemplary vinyl monomers include, but are not limited to, styrene, vinyl pyridine, acrylate, methacrylate, acrylonitrile, vinyl ester, vinyl chloride, isoprene.

Suitable vinyl ester monomers include aliphatic vinyl esters having 3 to 20 carbon atoms (e.g., 4 to 10 carbon atoms, or 4 to 7 carbon atoms). Exemplary vinyl esters are vinyl acetate, vinyl formate, vinyl propionate, vinyl valerate, vinyl butyrate, vinyl isobutyrate, vinyl pivalate, vinyl caprate, vinyl laurate, vinyl stearate, and vinyl versatate. Aromatic vinyl esters such as vinyl benzonate can also be used as vinyl ester monomers. Common vinyl ester monomers are vinyl acetate, vinyl propionate, vinyl laurate, or vinyl versatate (e.g., the vinyl ester of versatic acid, vinyl neononanoate, or vinyl neodecanoate). Typically, vinyl acetate is used from the perspective of good commercial availability and impurity-treating efficiency at the production. The vinyl esters of neononanoic acid (vinyl neononanoate) and neodecanoic acid (vinyl neodecanoate) are commercial products obtained from the reaction of acetylene with neononanoic acids and neodecanoic acids, respectively, which are commercially available as Versatic acid 9 and Versatic acid 10.

The starting polymer may be comprised of reacted units of a single monomer or two or more different monomers. In some embodiments, the polymer is comprised of reacted units of one or more monomers selected from the group consisting of ethylene, propylene, 1-butene, 1-pentene, 1-hexene, 1-heptene, 1-octene, and vinyl acetate.

In one embodiment, the starting polymer is polyethylene, derived from an ethylene monomer. The ethylene polymer may be high-density polyethylene (HDPE), linear low-density polyethylene (LLDPE), low-density polyethylene (LDPE), or medium-density polyethylene (MDPE). In another embodiment, the starting polymer is a vinyl acetate polymer derived from a vinyl acetate monomer. In yet another embodiment, the starting polymer is an ethylene-vinyl acetate copolymer derived from ethylene and vinyl acetate monomers. Ethylene-vinyl acetate (EVA) copolymers, also known as poly (ethylene-vinyl acetate) (PEVA), can vary depending upon different vinyl acetate (VA) content: e.g., low-VA (approximately up to 4%) EVA, which has properties similar to a LDPE but has increased gloss, softness, and flexibility; medium-VA (approximately 4-30%) EVA, having properties of a thermoplastic elastomer material; and high-VA (greater than 33%) EVA, having properties similar to a rubber.

The starting polymer of the present invention can have a molecular weight of from 1×10² g/mol to 1×10⁷ g/mol, determined via gel permeation chromatography.

### Polymerization and Crosslinking Reaction

Another aspect of the invention relates to a method of making a crosslinked polymer, comprising: reacting a starting polymer with a crosslinker, the crosslinker comprising a —Sₙ— moiety and having at least two polymerizable groups, wherein n is an integer of from 2 to 8. The reaction takes place in the presence of a free-radical generator, via a solid-state grafting, melt-state grafting, reactive extrusion, or melt mixing process, to produce a crosslinked polymer containing dynamic crosslinks.

All above descriptions and all embodiments relating to the crosslinked polymer composition, including the crosslinkers and the starting polymer, discussed above, are applicable to this aspect of the invention.

The crosslinker is preferably a dynamic crosslinker that has at least two polymerizable groups (e.g., a C═C double bond) that allow for the incorporation of the crosslinker into the polymer network during the reaction process. Because of the polymerizable groups contained in the dynamic crosslinker, the dynamic crosslinker can serve as another monomer during the polymerization, forming a copolymer or terpolymer with the monomer or monomers. For instance, reacting a polyethylene polymer with a diallyl disulfide as the crosslinker can generate an ethylene/diallyl disulfide copolymer; reacting an ethylene-vinyl acetate copolymer with a diallyl disulfide as the crosslinker can generate an ethylene/vinyl acetate/diallyl disulfide terpolymer. The dynamic crosslinker also serve to link the polymer chains together in various ways, forming an extensive crosslinking network.

In the embodiment relating to the method of making the crosslinked polymer, the reaction between the polymer and the crosslinker takes place via a reactive extrusion process. As one skilled in the art can appreciate, a reactive extrusion process is a manufacturing method that combines the traditionally separated chemical processes (polymer synthesis and/or modification) and extrusion (melting, mixing, melt mixing, blending, structuring, devolatilization and/or shaping) carried out onto an extruder. In this case, the chemical process is the reaction between the polymer (such as polyethylene polymer, polyethylene copolymer, or EVA polymer) and the crosslinker (such as disulfide crosslinker), which takes place in an extruder. The reactive extrusion process can be a single-step process, or reactive extrusion can involve two or more steps, performed in a sequence. In the multi-step process, the reaction between the polymer and the crosslinker can be completed in a later or additional heating step. The heating step can therefore represent the last step in the multi-step process. In one embodiment, the reactive extrusion process involves a melt mixing step that takes place at or above the softening temperature of the polymer. It can take place using any of an intermeshing mixer, a dispersing mixer, a high sheer mixer, a kneader, a single screw extruder, and a twin screw extruder, and a conical extruder.

The polymer networks produced through reactive extrusion will be crosslinked and contain a dynamic disulfide bond that allows the polymer network to be reprocessed. It is believed that the reactive extrusion assists in incorporating the crosslinker into a polymer network formed with or from the starting polymer.

Advantageously, the dynamically crosslinked networks of the crosslinked polymer composition produced through this method exhibit the same or better properties when compared to similar polymer compositions containing covalently crosslinked networks. Such properties include melting point, degree of crystallinity, glass transition temperature, mechanical strength, % gel fraction, tensile properties, Young's modulus, creep, and stress relaxation.

The reaction between the starting polymer and the crosslinker is a reaction carried out in the presence of a free-radical generator. Free-radical generator can promote a type of chain-growth (chain-addition) polymerization that starts by initiating free radicals which add monomer or polymer units, thereby growing the polymer chain. Any type of initiation to generate free radicals (free radical initiation) can be suitable herein for these reactions. The free-radical generator comprises heat, a small-molecule free radical generator compound, or both. The free-radical generation can be a result of the methods of the present invention, such as the solid-state grafting, melt-state grafting, reactive extrusion, or melt mixing, of the present invention, where the processes thereof, such as heating taking place in grafting, reactive extrusion, or melt mixing, causes the free radicals to be generated.

The free-radical polymerization generator may comprise a small-molecule free radical generator compound, such as a peroxide (e.g., a bifunctional peroxide, a peracetate compound, etc.), an azo compound, a nitroxide, other —C—C— free radical generators, and a mixture thereof.

Suitable peroxide compounds used as the polymerization generator include, but are not limited to, a cyclic ketone peroxide, a bifunctional peroxide, a dialkyl peroxide, a monoperoxycarbonate, a poly (t-butyl) peroxycarbonates polyether, a di-peroxyketal, a perester (e.g., a peracetate), and mixtures thereof. In some embodiments, the peroxide compound is a cyclic ketone peroxide, a bifunctional peroxide, a dialkyl peroxide, or a mixture thereof.

Exemplary peroxide compounds used as the polymerization generator are benzoyl peroxide; dicumyl peroxide; di-tert-butyl peroxide; tert-butyl cumyl peroxide; t-butyl-peroxy-2-ethyl-hexanoate; tert-butyl peroxypivalate; tertiary butyl peroxyneodecanoate; t-butyl-peroxybenzoate; t-butyl-peroxy-2-ethyl hexanoate; tert-butyl 3,5,5-trimethylhexanoate peroxide; tert-butyl peroxybenzoate; 2-ethylhexyl carbonate tert-butyl peroxide; 2,5-dimethyl-2,5-di(tert-butylperoxide) hexane; 1,1-di(tert-butylperoxide)-3,3,5-trimethylcyclohexane; 2,5 dimethyl-2,5-di(tert-butylperoxide) hexyne-3; 3,3,5,7,7 pentamethyl-1,2,4-trioxepane; butyl 4,4-di(tert-butylperoxide) valerate; di(2,4-dichlorobenzoyl) peroxide; di(4-methylbenzoyl) peroxide; peroxide di(tert butylperoxyisopropyl)benzene; 2,5-di(cumylperoxy)-2,5-dimethyl hexane; 2,5-di(cumylperoxy)-2,5-dimethylhexyne; 3,4-methyl-4-(t-butylperoxy)-2-pentanol; 4-methyl-4-(t-amylperoxy)-2-pentano1; 4 methyl-4-(cumylperoxy)-2-pentanol; 4-methyl-4-(t-butylperoxy)-2-pentanone; 4-methyl-4-(t-amylperoxy)-2 pentanone; 4-methyl-4-(cumylperoxy)-2-pentanone; 2,5 dimethyl-2,5-di-t-butylperoxy) hexane; 2,5-dimethyl-2,5-di(t-amylperoxy) hexane; 2,5-dimethyl-2,5-di(t-butylperoxy) hexyne-3,2,5-dimethyl-2,5-di(t-amylperoxy) hexyne-3,2,5-dimethyl-2-t-butylperoxy-5-hydroperoxyhexane; 2,5-dimethyl-2-cumylperoxy-5-hydroperoxy hexane; 2,5-dimethyl-2-t-amylperoxy-5-hydroperoxyhexane; m/p-alpha, alpha-di[(t-butylperoxy)isopropyl]benzene; 1,3,5-tris(t-butylperoxyisopropyl)benzene; 1,3,5-tris(t-amylperoxyisopropyl)benzene; 1,3,5-tris(cumylperoxyisopropyl)benzene; di[1,3-dimethyl-3-(t-butylperoxy)butyl]carbonate; di[1,3-dimethyl-3-(t-amylperoxy)butyl]carbonate; di[1,3-dimethyl-3-(cumylperoxy)butyl]carbonate; di-t-amyl peroxide; t-amyl cumyl peroxide; t-butyl-isopropenylcumyl peroxide; 2,4,6-tri(butylperoxy)-s-triazine; 1,3,5-tri[1-(t-butylperoxy)-1-methylethyl]benzene; 1,3,5-tri-[(t-butylperoxy)-isopropyljbenzene; 1,3-dimethyl-3-(t-butylperoxy)butanol; 1,3-dimethyl-3-(t-amylperoxy)butanol; di(2-phenoxyethyl) peroxydicarbonate; di(4-t-butylcyclohexyl) peroxydicarbonate; dimyristyl peroxydicarbonate; dibenzyl peroxy decarbonate; di(isobornyl) peroxydicarbonate; 3-cumylperoxy-1,3-dimethylbutyl methacrylate; 3-t-butylperoxy-1,3-dimethylbutyl methacrylate; 3-t-amylperoxy-1,3-dimethylbutyl methacrylate; tri(1,3-dimethyl-3-t-butylperoxy butyloxy) vinyl silane; 1,3-dimethyl-3-(t-butylperoxy)butyl N-[1-{3-(1-methylethenyl)-phenyl) 1-methylethyl]carbamate; 1,3-dimethyl-3-(t-amylperoxy)butyl N-[1-{3 (1-methylethenyl)-phenyl}-1-methylethyl]carbamate; 1,3-dimethyl-3-(cumylperoxy))butyl N-[1-{3-(1-methylethenyl)-phenyl}-1-methylethyl]carbamate; 1,1-di(t-butylperoxy)-3,3,5-trimethylcyclohexane; 1,1-di(t-butylperoxy)cyclohexane; n-butyl 4,4-di(t-amylperoxy) valerate; ethyl 3,3-di(t-butylperoxy)butyrate; 2,2-di(t-amylperoxy) propane; 3,6,6,9,9-pentamethyl-3-ethoxycabonylmethyl-1,2,4,5-tetraoxacyclononane; n-butyl-4,4-bis(t-butylperoxy) valerate; ethyl-3,3-di(t-amylperoxy)butyrate; benzoyl peroxide; OO-t-butyl-O-hydrogen-monoperoxy-succinate; OO-t-amyl-O-hydrogen-monoperoxy-succinate; 3,6,9, triethyl-3,6,9-trimethyl-1,4,7-triperoxynonane (or methyl ethyl ketone peroxide cyclic trimer); methyl ethyl ketone peroxide cyclic dimer; 3,3,6,6,9,9-hexamethyl-1,2,4,5-tetraoxacyclononane; 2,5-dimethyl-2,5-di(benzoylperoxy) hexane; t-butyl perbenzoate, t-butylperoxy acetate; t-butylperoxy-2-ethyl hexanoate; t-amyl perbenzoate; t-amyl peroxy acetate; t-butyl peroxy isobutyrate; 3-hydroxy-1,1-dimethyl-t-butyl peroxy-2-ethyl hexanoate; OO-t-amyl-O-hydrogen-monoperoxy succinate; OO-t-butyl-O-hydrogen-monoperoxy succinate; di-t-butyl diperoxyphthalate; t-butylperoxy (3,3,5-trimethylhexanoate); 1,4-bis(t-butylperoxycarbo)cyclohexane; t-butylperoxy-3,5,5-trimethylhexanoate; t-butyl-peroxy-(cis-3-carboxy) propionate; allyl 3-methyl-3-t-butylperoxy butyrate; OO-t-butyl-O-isopropylmonoperoxy carbonate; OO-t-butyl-O-(2-ethyl hexyl) monoperoxy carbonate; 1,1,1-tris[2-(t-butylperoxy-carbonyloxy) ethoxymethyl]propane; 1,1,1-tris[2-(t-amylperoxy-carbonyloxy) ethoxymethyl]propane; 1,1-tris[2-(cumylperoxy-cabonyloxy) ethoxymethyl]propane; OO-t-amyl-O-isopropylmonoperoxy carbonate; di(4-methylbenzoyl) peroxide; di(3-methylbenzoyl) peroxide; di(2-methylbenzoyl) peroxide; didecanoyl peroxide; dilauroyl peroxide; 2,4-dibromo-benzoyl peroxide, succinic acid peroxide, dibenzoyl peroxide; di(2,4-dichloro-benzoyl) peroxide; and combinations thereof.

Suitable azo compounds used as the polymerization generator include, but are not limited to azobisisobutyronitrile (AIBN); 2,2′-azobis(amidinopropyl) dihydrochloride; and azo-peroxide generators that contain mixtures of a peroxide with one or more azodinitrile compounds including, e.g., 2,2′-azobis(2-methyl-pentanenitrile); 2,2′-azobis(2-methyl-butanenitrile); 2,2′-azobis(2-ethyl-pentanenitrile); 2-[(1-cyano-1-methylpropyl) azo]-2-methyl-pentanenitrile; 2-[(1-cyano-1-ethylpropyl) azo]-2-methyl-butanenitrile; and 2-[(1-cyano-1-methylpropyl) azo]-2-ethyl-pentanenitrile.

Suitable nitroxide compounds used as the free-radical generator include, but are not limited to 2,2,5,5-tetramethyl-1-pyrrolidinyloxy, 3-carboxy-2,2,5,5-tetramethyl-pyrrolidinyloxy, 2,2,6,6-tetramethyl-1-piperidinyloxy, 4-hydroxy-2,2,6,6-tetramethyl-1-piperidinyloxy, 4-methoxy-2,2,6,6-tetramethyl-1-piperidinyloxy, 4-oxo-2,2,6,6-tetramethyl-1-piperidinyloxy, bis-(1-oxyl-2,2,6,6-tetramethylpiperidine-4-yl) sebacate, 2,2,6,6-tetramethyl-4-hydroxypiperidine-1-oxyl) monophosphonate, N-tert-buty 1-1-diethylphosphono-2,2-dimethyl propyl nitroxide, N-tert-buty 1-1-dibenzylphosphono-2,2-dimethylpropyl nitroxide, N-tert-butyl-1-di(2,2,2-trifluoroethyl)phosphono-2,2dimethylpropyl nitroxide, N-tert-butyl-(1-diethylphosphono)-2-methyl-propyl nitroxide, N-(1-methylethyl)-1-cyclohexyl-1-(diethylpho sphono) nitroxide, N-(1-phenylbenzyl)-(1-diethylphosphono)-1-methyl ethyl nitroxide, N-phenyl-1-diethylphosphono-2,2-dimethyl propyl nitroxide, N-phenyl-1-diethylphosphono-1-methyl ethyl nitroxide, N-(1-phenyl 2-methyl propy 1)-1-diethylphosphono-1-methyl ethyl nitroxide, N-tert-butyl-1-phenyl-2-methyl propyl nitroxide, N-tert-butyl-1-(2-naphthyl)-2-methyl propyl nitroxide, and combinations thereof.

In some embodiments, the free-radical generator comprises at least one member selected from the group consisting of 2,3-dimethyl-2,3-diphenylbutane; 3,4-dimethyl-3,4-diphenylhexane; 3,4-diethyl-3,4-diphenylhexane; 3,4-dibenzyl-3,4-ditolylhexane; 2,7-dimethyl-4,5-diethyl-4,5-diphenyloctane; and 3,4-dibenzyl-3,4-diphenylhexane.

To initiate the polymerization and/or crosslinking reaction, the amount of the polymerization generator present in the composition typically ranges from 1×10⁻⁷ wt % to 5.0 wt %, for instance, from 0.001 wt % to 5.0 wt %, from 0.05 wt % to 5.0 wt %, from 0.01 wt % to 5.0 wt %, from 0.05 wt % to 5.0 wt %, from 0.01 wt % to 4.0 wt %, from 0.05 wt % to 4.0 wt %, from 0.01 wt % to 3.0 wt %, from 0.05 wt % to 3.0 wt %, from 0.01 wt % to 2.0 wt %, from 0.05 wt % to 2.0 wt %, from 0.01 wt % to 1.0 wt %, from 0.05 wt % to 1.0 wt %, from 0.1 wt % to 1.0 wt %, or from 0.1 wt % to 0.5 wt %, relative to 100 wt % of the total amount of the composition (comprising the crosslinker, polymer, and polymerization generator).

The reaction is typically carried out at an elevated temperature under a wide temperature range, and can be carried out in an extruder, or other mixing device, that can be temperature controlled. The reaction temperature for the solid-state grafting, melt-state grafting, reactive extrusion, or melt mixing, is typically at least 70° C., and can range from 70° C. to 350° C., for instance, from 150° C. to 350° C., from 150° C. to 280° C., from 150° C. to 230° C., from 150° C. to 180° C., from 70° C. to 280° C., from 70° C. to 230° C., from 70° C. to 200° C., from 70° C. to 180° C., or from 70° C. to 130° C. Suitable reaction temperatures should take into consideration the polymerization generator/initiator used and the dynamic crosslinker used. For instance, suitable reaction temperatures should be at least higher than the decomposition temperature of the polymerization generator. Suitable reaction temperatures should also be no higher than the dissociation temperature of the crosslinker so that the crosslinking bonds (i.e., the disulfide or polysulfide linkages) in the crosslinker do not dissociate during the reaction.

The reaction conditions may also involve the use of an inert gas (e.g., N₂ gas).

The reaction may be carried out in the presence or absence of a solvent. The solvent may be used to dissolve the monomer or dynamic crosslinker. Suitable solvents include, but are not limited to, deep eutectic solvents; eutectic mixtures; ionic liquids; dimethyl carbonate (green solvent); ethers such as petroleum ether, tetrahydrofuran, or 1,4-dioxane; hydrocarbon solvents such as cyclohexane, heptane, or toluene; esters such as ethyl acetate; ketones (such as acetone or butanone); chlorinated solvents, such as dichloromethane; alcohols such as methanol, ethanol, isopropanol, ethylene glycol, or glycerol; and combinations thereof. In some embodiments, the solvent is an anhydrous liquid. In one embodiment, the solvent is dimethyl carbonate.

The reaction between the crosslinker and the starting polymer, whether via repolymerization, solid-state grafting, melt-state grafting, reactive extrusion, or melt extrusion, may be carried out in a batch process as a bulk reaction or in a continuous process as a continuous reaction, under the reaction temperature as discussed above.

### The Reversibly-Crosslinked Polymer and its Reprocessing

The method discussed above results in a reversibly-crosslinked polymer. Thus, another aspect of the invention relates to reversibly-crosslinked polymer obtained according to the method as described from the above aspect of the invention.

All above descriptions and all embodiments regarding the polymer composition, including the crosslinkers and polymers, discussed above in the aspect of the invention relating to the polymer composition, are applicable to this aspect of the invention.

All above descriptions and all embodiments regarding the method of making a crosslinked polymer, including the free-radical polymerization generator, various suitable reagents, reaction mechanisms, and reaction conditions discussed above in the aspect of the invention relating to the method of making a crosslinked polymer, are applicable to this aspect of the invention.

As discussed above, the method generates a reversibly-crosslinked polymer, comprising the reaction product of the polymerized composition and crosslinker, as discussed herein above. In the resulting reversibly-crosslinked polymer, the dynamic crosslinker may be incorporated into the reversibly-crosslinked polymer in an amount of from about 0.01 wt % to about 50 wt %, for instance, in an amount ranging from 0.05 wt % to 50 wt %, from 0.1 wt % to 50 wt %, from 0.5 wt % to 50 wt %, from 1 wt % to 50 wt %, from 5 wt % to 50 wt %, from 0.1 wt % to 40 wt %, from 0.5 wt % to 40 wt %, from 1 wt % to 40 wt %, from 5 wt % to 40 wt %, from 0.1 wt % to 30 wt %, from 0.5 wt % to 30 wt %, from 0.1 wt % to 20 wt %, from 0.5 wt % to 20 wt %, from 1 wt % to 20 wt %, from 5 wt % to 20 wt %, from 0.1 wt % to 10 wt %, from 0.5 wt % to 10 wt %, from 1 wt % to 10 wt %, or from 5 wt % to 10 wt %, relative to 100 wt % of the total amount of the reversibly-crosslinked polymer.

The resulting polymer network in the reversibly-crosslinked polymer comprises a —S—S— bond that is dynamic and can undergo dissociation and reassociation at different conditions (e.g., upon changing the temperature), allowing for the polymer to be re-processed and recycled when the polymer is subjected to a stimulus.

The resulting reversibly-crosslinked polymer may be reprocessed by heating from a temperature at which dissociation of the reversible crosslinking bonds (e.g., —S—S— bonds) is inactive or substantially inactive (e.g., at room temperature) to an elevated temperature at which the dissociation of the reversible crosslinking bonds (e.g., —S—S— bonds) is activated or significantly enhanced (e.g., at temperatures greater than 50° C., greater than 60° C., greater than 70° C., greater than 80° C., greater than 90° C., greater than 100° C., greater than 110° C., greater than 120° C., greater than 130° C., greater than 140° C., greater than 150° C., or greater than 180° C., depending on the individual crosslinker used). Thus, suitable reprocessing/recycling temperatures can be at least 50° C., at least 60° C., at least 70° C., at least 80° C., at least 90° C., at least 100° C., at least 110° C., at least 120° C., at least 130° C., at least 140° C., at least 150° C., or at least 180° C., depending on the individual crosslinker used. In some embodiments, the reprocessing/recycling temperatures are in a range of 120° C. to 200° C., such as 120, 130, 140, 150, 160, 170, 180, 190, and 200° C., and any integer in between. The polymers may be reshaped (e.g., remolded) at the reprocessing/recycling temperatures. Then the reprocessed/recycled polymers can be cooled down, e.g., back to room temperature. During cooling, the reversible linkage (e.g., —S—S— bond) reassociates, thereby reforming the polymer network. A single reprocessing/recycling cycle may be a single round of heating, reshaping, and cooling. The heating used to reprocess/recycle the reversibly-crosslinked polymers can be relatively short (e.g., 5 hours, 4 hours, 3 hours, 2 hours, 1 hour, 30 minutes, or less) and still provide the reprocessed polymer network with full recovery of crosslinking density (as compared to the initial polymer network prior to any reprocessing/recycling).

Another embodiment of the invention relates to a reprocessed polymer produced by the reprocessing step noted above. For instance, a reprocessed polymer produced heating the reversibly-crosslinked polymer to a temperature of 50° C. or more, or a reprocessed polymer produced heating the reversibly-crosslinked polymer to a temperature of 150° C. or more.

The reversibly-crosslinked polymer after a reprocessing/recycling cycle maintains the polymer properties (as compared to those of the original polymer prior to any reprocessing/recycling). Thus, the polymerized composition and method described herein allow for preparation of a fully reprossessible/recyclable polymer (as compared to conventional polymers prepared without using the dynamic crosslinkers described herein). Accordingly, another embodiment of this invention relates to a reprocessed polymer produced by the process of making the crosslinked polymer described above.

### Uses

The crosslinked polymer compositions of the present invention are useful in the production of thin-film encapsulant materials, in applications such as solar panels. In general, polymeric encapsulant materials are crosslinked, when on a solar panel. Recycling the crosslinked encapsulant materials, at present, is difficult, and instead are often burned off, so that the solar panels can be recycled. A dynamically crosslinked polymer of the present invention, is a candidate for an encapsulant that would be recyclable itself, avoiding a costly burning stage of the recycling process currently in use. In addition, the crosslinked polymer compositions of the present invention can be used in wire/cable applications, automotive applications, pipe applications, PE foam applications, and other composites.

### Schematic Example

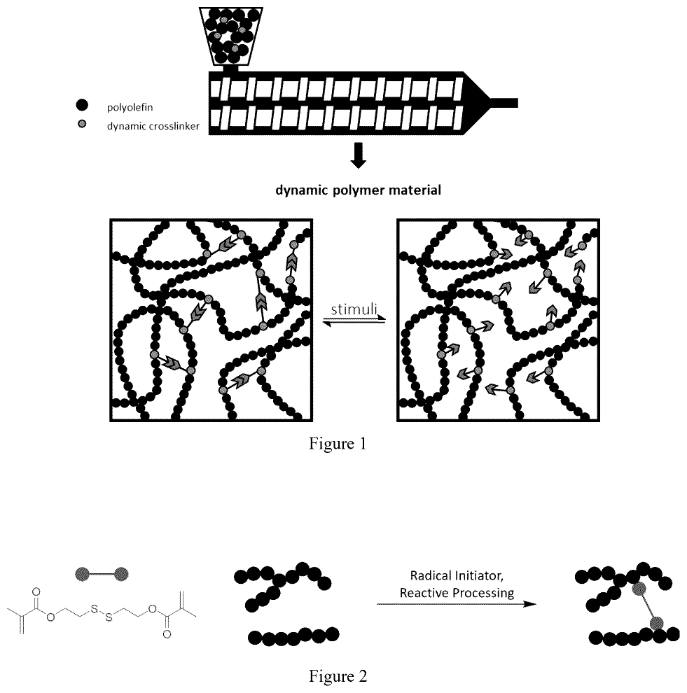

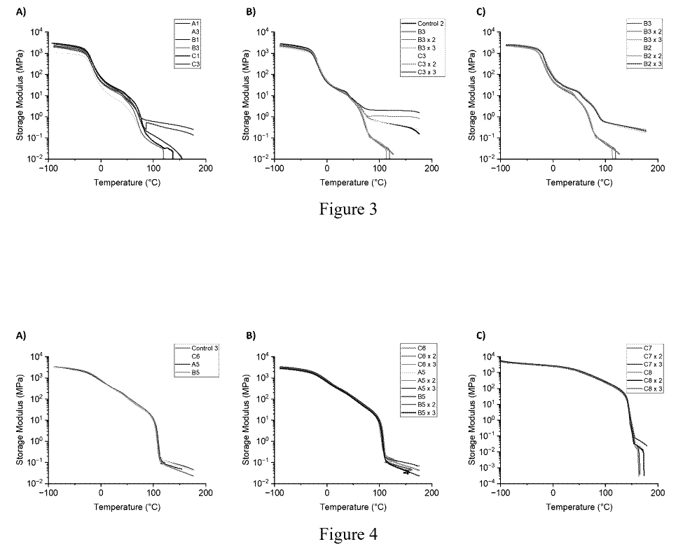

FIGS. 1 and 2 show a schematic examples of methods of making a crosslinked polymer, according to the present invention. For instance, a starting polymer, being a polyolefin, is introduced into an extruder, via a hopper, along with a crosslinker compound, and free radical generator (not shown). The polyolefin, crosslinker compound, and free radical generator are passed through the extruder, either agitated enough to cause free radical generation in the free radical generator, or heated enough to cause free radical generation. As a result, the crosslinker incorporates into the polymer network. Stimuli, such as heat, can break a —S—S— bond of the crosslinker, to demonstrate the reversible crosslinking of the polymer network.

### EXAMPLES

A series of polyethylene and ethylene-vinyl acetate (EVA) copolymers underwent reactive processing with a dynamic disulfide crosslinker of the following motif: C—S—S—C (FIG. 2). The reactive processing was conducted in a micro compounder with a free radical initiator to produce dynamically crosslinked polymers. To characterize the samples, differential scanning calorimetry (DSC) and dynamic mechanical analysis (DMA) were performed. DSC was performed under nitrogen in a TA Q2000 instrument. Samples were heated to 300° C. at 10° C./min, held at this temperature for 1 minute, cooled down to −20° C. at 10° C./min and held at this temperature for 1 minute. The sample was then heated up to 300° C. at 10° C./min. Table 1 and 2 shows the temperature of crystallization (T_{c}), melting temperature (Tₘ, second melting cycle), and endothermic ΔH (J/g, second melting cycle) for various samples. DMA was performed on a TA 800 DMA instrument in tensile mode. The sample is cooled to −100° C. and a temperature sweep was performed to 80° C. 3° C./min to determined viscoelastic response. A preload force of 0.01 N with a frequency of 1 Hz was applied, and a set amplitude is predetermined via strain sweep.

### Example 1

In this example, ethylene-vinyl acetate copolymers were dynamically crosslinked via reactive processing. For the base resin, two different grades of EVA, EVA 1 and EVA 2, were used, both with the same vinyl acetate content at 28%, but EVA 2 (MFR 25 g/10 min) had a higher melt flow value than EVA 1 (MFR 6 g/10 min). Both EVA 1 and EVA 2 were made in an autoclave. Dicumyl peroxide was used as the radical initiator in 1 wt %. For reactive processing the base resin was dry blended with the desired dynamic disulfide crosslinker and dicumyl peroxide. The blend was added into an Xplore microcompounder and mixed at 100° C. for 5 minutes. The temperature was then increased to 140° C. for 20 minutes or until the force reached 7000N. The mixture was extruded and pelletized (Table 1). Films for DMA were pressed in a Carver press at 150° C. for 1 hour. Films for reprocessability studies were pressed in a Carver press at 150° C. for 1 hour with 8-10 tons of pressure and then put in a cold press (room temperature) for 5 minutes with 8-10 tons of pressure. The press 1× molded sample was then cut up into 3-5 mm pieces and repressed with the same conditions (150° C. for 1 hour with 8-10 tons of pressure). The same process was performed to obtain a press 3× molded sample. The reprocessability indicates the dynamic nature of the polymer network.

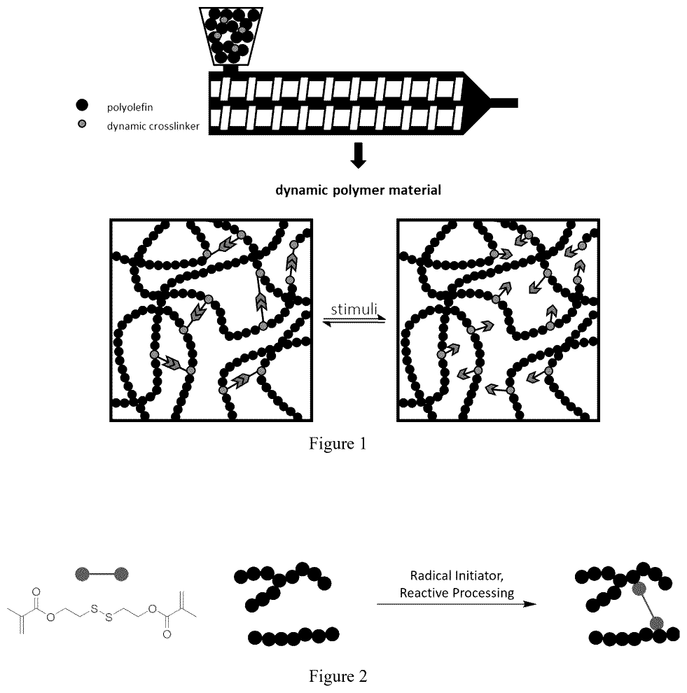

To examine if the samples were crosslinked and reprocessable, DMA was performed (FIG. 3). FIG. 3A, depicts the storage modulus of two EVA base resins with three different dynamic disulfide crosslinkers. Two samples were selected to examine the reprocessability (Table 1, samples B3 and B3). Sample B3 exhibited loss in storage modulus over the three reprocessing cycles, whereas sample C3 exhibited an increase in storage modulus over the three reprocessing cycles (FIG. 3B). To further explore the reprocessability, two concentrations of dynamic crosslinker were examined Table 1, B2 and B3. The sample with a lower concentration of dynamic crosslinker exhibited a storage modulus with no loss in properties over the three reprocessing cycles (FIG. 3C). Crosslinker A is DSDMA, crosslinker B is BAC, and crosslinker C is 4MUPD.

TABLE 1
Reactive Processing with EVA as Base Resin

| | | | | Mixing | Reaction | | | Endothermic |
|---|---|---|---|---|---|---|---|---|
| | Base | Crosslinker | | Temp | Temp | Tc | Tm | ΔH |
| Sample | Resin | | wt % | (° C.) | (° C.) | (° C.) | (° C.) | (J/g) |
| A1 | EVA 1 | A | 2 | 100 | 140 | 57.3 | 72.7 | 49.4 |
| A2 | EVA 1 | A | 5 | 100 | 140 | 54.6 | 70.8 | 48.2 |
| A3 | EVA 2 | A | 2 | 100 | 140 | 54.3 | 70.2 | 43.4 |
| A4 | EVA 2 | A | 5 | 100 | 140 | 54.5 | 70.4 | 40.8 |
| B1 | EVA 1 | B | 2 | 100 | 140 | — | — | — |
| B2 | EVA 1 | B | 1 | 100 | 140 | — | — | — |
| B3 | EVA 2 | B | 2 | 100 | 140 | 52.8 | 70.3 | 39.5 |
| B4 | EVA 2 | B | 5 | 100 | 140 | 53.5 | 70.3 | 39.9 |
| C1 | EVA 1 | C | 2 | 100 | 140 | 59.6 | 74.7 | 55.3 |
| C2 | EVA 1 | C | 5 | 100 | 140 | 49.2 | 65.8 | 51.8 |
| C3 | EVA 2 | C | 2 | 100 | 140 | 48.6 | 65.1 | 40.1 |
| C4 | EVA 2 | C | 5 | 100 | 140 | — | — | — |
| Control 1 | EVA 1 | — | — | 100 | 140 | — | — | — |
| Control 2 | EVA 2 | — | — | 100 | 140 | 48.4 | 66.2 | 37.5 |

### Example 2

In this example, polyethylene was dynamically crosslinked via reactive processing. For the base resin, a high density polyethylene (HDPE—MFR 25 g/10 min) and a low density polyethylene (LDPE—MFR 2.7 g/10 min) were used. The radical initiator was selected from dicumyl peroxide, Trigonox 301, or Trigonox 101 and used in 1 wt %. For reactive processing the base resin was dry blended with the desired dynamic disulfide crosslinker and radical initiator. The blend was added into an Xplore microcompounder and mixed at 100-140° C. for 5 minutes (depending on base resin and radical initiator). The temperature was then increased to 140-180° C. for 20 minutes or until the force reached 7000N (depending on base resin and radical initiator). The mixture was extruded and pelletized (Table 2). Films for DMA were pressed in a Carver press at 180° C. for 1 hour. Films for reprocessability studies were pressed in a Carver press at 180° C. for 1 hour with 8-10 tons of pressure and then put in a cold press (room temperature) for 5 minutes with 8-10 tons of pressure. The press 1× molded sample was then cut up into 3-5 mm pieces and repressed with the same conditions (180° C. for 1 hour with 8-10 tons of pressure). The same process was performed to obtain a press 3× molded sample.

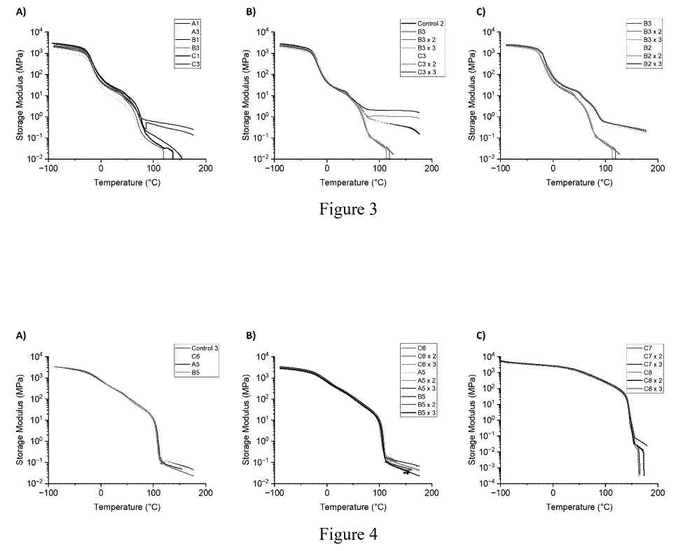

To examine if the samples were crosslinked and reprocessable, DMA was performed (FIG. 4). FIG. 4A, depicts the storage modulus of an LDPE base resin with three different dynamic disulfide crosslinkers (Table 2, A5, B5, C6). Each of the samples underwent a reprocessability study (FIG. 4B). All the samples exhibit a rubbery plateau and maintain the storage modulus over three reprocessing steps. Two samples were selected to examine the reprocessability (Table 1, B3 and B3). An HDPE was also examined with the reactive processing procedure (FIG. 4C). Crosslinker A is DSDMA, crosslinker B is BAC, and crosslinker C is 4MUPD.

TABLE 2
Reactive Processing with Polyethylene as Base Resin

| | | | | Mixing | Reaction | | | Endothermic |
|---|---|---|---|---|---|---|---|---|
| | Base | Crosslinker | | Temp | Temp | Tc | Tm | ΔH |
| Sample | Resin | | wt % | (° C.) | (° C.) | (° C.) | (° C.) | (J/g) |
| A5 | LDPE | A | 2 | 130 | 150 | — | — | — |
| B5 | LDPE | B | 2 | 130 | 150 | — | — | — |
| C5 | LDPE | C | 2 | 100 | 140 | 61.8/100.3 | 109.8 | 149.1 |
| C6 | LDPE | C | 2 | 100 | 140 | — | — | — |
| C7 | HDPE | C | 2 | 140 | 180 | — | — | — |
| C8 | HDPE | C | 5 | 140 | 180 | — | — | — |
| Control 3 | LDPE | — | — | 130 | 150 | 99.6 | 110.6 | 133.9 |
| Control 4 | HDPE | — | — | 140 | 180 | — | — | — |

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112 (f) for any limitations of any of the claims herein, except for those in which the claim expressly uses the words ‘means for’ together with an associated function.

1. A crosslinked polymer composition, comprising a crosslinked polymer, being a reaction product of a starting polymer and a crosslinker, represented by Formula (I), (II), (III), (IV), or (V):
R¹R²R³C—Sₙ—CR⁴R⁵R⁶ (I)
R⁷—CH(X)—Sₙ—CH(Y)—R⁸ (II)
R⁷-B₁-A₁-Sₙ-A₂-B₂-R⁸ (III)
R¹⁵—O—Sₙ—O—R¹⁶ (IV)
(R¹⁷)(R¹⁸)—P—Sₙ—P—(R¹⁹)(R²⁰) (V)
wherein:
n is an integer of from 2 to 8;
X represents CHR⁹R¹⁰, OH, SH, or NHR¹¹;
Y represents CHR¹²R¹³, OH, SH, or NHR¹⁴;
each of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, R¹⁸, R¹⁹, and R²⁰ is independently selected from the group consisting of a hydrogen atom, a halogen atom, a C₁₋₂₀ linear or branched alkyl, a C₂₋₂₀ alkenyl, a C₂₋₂₀ alkynyl, a nitrile, a hydroxyl, an ester having from 1 to 20 carbon atoms, an ether having from 1 to 20 carbon atoms, a thioether having from 1 to 20 carbon atoms, a ketone having from 1 to 20 carbon atoms, an imine, an amide, a primary amine, a secondary amine, a tertiary amine, a trifluoromethyl, a phenyl, a benzyl, a phenol, a pentafluorophenyl, a nitroxyl, and a silane having from 1 to 20 carbon atoms; each optionally substituted by one or more alkyl, alkenyl, hydroxyl, or halogen atoms;
each of A₁ and A₂ is independently absent, a C₁-C₂₀ alkylene, a C₂-C₂₀ cycloalkylene, a divalent form of C₂-C₂₀ alkene, a divalent form of C₂-C₂₀ alkyne, an arylene, or combinations thereof, each optionally substituted by one or more alkyl, alkenyl, hydroxyl, or halogen atoms;
each of B₁ and B₂ is independently absent or a divalent form of imine, amine, carbamide, carbonyl amide, ether, or ester, or combinations thereof;
provided that:
in Formula (I), at least one of R¹, R², and R³ comprises a C═C double bond, and at least one of R⁴, R⁵, and R⁶ comprises a C═C double bond,
in Formula (II) and (III), each of R⁷ and R⁸ comprises a C═C double bond,
in Formula (IV), each of R¹⁵ and R¹⁶ comprises a C═C double bond, and
in Formula (V), at least one of R¹⁷ and R¹⁸ comprises a C═C double bond, and at least one of R¹⁹ and R²⁰ comprises a C═C double bond.

2. The crosslinked polymer composition according to claim 1, wherein n is 2 or 3.

3. The crosslinked polymer composition according to claim 1, wherein the crosslinker is in the form of an ensemble of crosslinker molecules, each crosslinker molecule in the ensemble being a compound represented by Formula (I), (II), (III), (IV), or (V), and wherein for at least 90% of the crosslinkers molecules in the ensemble, n is equal to 2.

4. (canceled)

5. The crosslinked polymer composition according to claim 1, wherein the crosslinker further comprises, in addition to at least one crosslinker represented by Formula (I), (II), (III), (IV), or (V), a crosslinker represented by Formula (VI):
E₁-(R²¹)(R²²)N—Sₙ—N(R²³)(R²⁴)-E₂ (VI),
wherein each of E₁ and E₂ is independently a (meth)acrylate, (meth)acrylamide, a C₁-C₂₀ alkylene, a C₂-C₂₀ cycloalkylene, a divalent form of C₂-C₂₀ alkene, a divalent form of C₂-C₂₀ alkyne, an arylene, or combinations thereof, each optionally substituted by one or more alkyl, alkenyl, hydroxyl, or halogen atoms,
wherein the crosslinker represented by Formula (VI) is in the form of an ensemble of crosslinker molecules, and
wherein for at least 90% of the crosslinkers molecules represented by Formula (VI) in the ensemble, n is equal to 2.

6. (canceled)

7. The crosslinked polymer composition according to claim 1, wherein the C═C double bond is capable of undergoing a free-radical polymerization reaction and in a functional group comprising at least one member selected from the group consisting of an alkene, an alkyne, a nitrile, vinyl group, an acyl, an acrylate, a (meth)acrylate, (meth)acrylamide, a styrene, and a vinyl pyridine.

8. The crosslinked polymer composition according to claim 1, wherein the crosslinker comprises at least one member selected from the group consisting of allyl disulfide, diallyl disulfide, allyl trisulfide, diallyl trisulfide, bis(2-methacryloyl)oxyethyl disulfide (DSDMA), diallyl 2,2′-disulfanediyldibenzoate, diallyl 2,2′-disulfanediyldiacetate, diallyl 4,4′-disulfanediyldibutyrate, diallyl 3,3′-disulfanediyldipropionate, disulfanediylbis(3,1-phenylene) diacrylate, disulfanediylbis(ethane-2,1-diyl) diacrylate, N,N′-(disulfanediylbis(2,1-phenylene))diacrylamide, N,N′-(disulfanediylbis(4,1-phenylene))diacrylamide, N,N′-Bis(acryloyl)cystamine (BAC), and ((((disulfanediylbis(4,1-phenylene))bis(azanediyl))bis(carbonyl))bis(azanediyl))bis(ethane-2,1-diyl)bis(2-methylacrylate) (4MUPD).

9-13. (canceled)

14. The crosslinked polymer of claim 1, wherein the crosslinked polymer is a reversibly-crosslinked polymer.

15. A method of making a crosslinked polymer, comprising:
reacting, via solid-state grafting, melt-state grafting, reactive extrusion, or melt mixing, a starting polymer and at least one crosslinker, in the presence of a free-radical generator, the crosslinker being represented by Formula (I), (II), (III), (IV), or (V):
R¹R²R³C—Sₙ—CR⁴R⁵R⁶ (I)
R⁷—CH(X)—Sₙ—CH(Y)—R⁸ (II)
R⁷-B₁-A₁-Sₙ-A₂-B₂-R⁸ (III)
R¹⁵—O—Sₙ—O—R¹⁶ (IV)
(R¹⁷)(R¹⁸)—P—Sₙ—P—(R¹⁹)(R²⁰) (V)
wherein:
n is an integer of from 2 to 8;
X represents CHR⁹R¹⁰, OH, SH, or NHR¹¹;
Y represents CHR¹²R¹³, OH, SH, or NHR¹⁴,
each of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, R¹⁸, R¹⁹, and R²⁰ is independently selected from the group consisting of a hydrogen atom, a halogen atom, a C₁₋₂₀ linear or branched alkyl, a C₂₋₂₀ alkenyl, a C₂₋₂₀ alkynyl, a nitrile, a hydroxyl, an ester having from 1 to 20 carbon atoms, an ether having from 1 to 20 carbon atoms, a thioether having from 1 to 20 carbon atoms, a ketone having from 1 to 20 carbon atoms, an imine, an amide, a primary amine, a secondary amine, a tertiary amine, a trifluoromethyl, a phenyl, a benzyl, a phenol, a pentafluorophenyl, a nitroxyl, and a silane having from 1 to 20 carbon atoms; each optionally substituted by one or more alkyl, alkenyl, hydroxyl, or halogen atoms;
each of A₁ and A₂ is independently absent, a C₁-C₂₀ alkylene, a C₂-C₂₀ cycloalkylene, a divalent form of C₂-C₂₀ alkene, a divalent form of C₂-C₂₀ alkyne, an arylene, or combinations thereof, each optionally substituted by one or more alkyl, alkenyl, hydroxyl, or halogen atoms;
each of B₁ and B₂ is independently absent or a divalent form of imine, amine, carbamide, carbonyl amide, ether, or ester, or combinations thereof;
provided that:
in Formula (I), at least one of R¹, R², and R³ comprises a C═C double bond, and at least one of R⁴, R⁵, and R⁶ comprises a C═C double bond,
in Formula (II) and (III), each of R⁷ and R⁸ comprises a C═C double bond,
in Formula (IV), each of R¹⁵ and R¹⁶ comprises a C═C double bond, and
in Formula (V), at least one of R¹⁷ and R¹⁸ comprises a C═C double bond, and at least one of R¹⁹ and R²⁰ comprises a C═C double bond;
to produce a crosslinked polymer comprising a dynamic crosslink.

16. The method of claim 15, wherein the dynamic crosslink comprises a S—S chemical bond.

17. The method of claim 15, wherein the crosslinked polymer is a reversibly-crosslinked polymer.

18. The method according to claim 15, further comprising
reprocessing the reversibly-crosslinked polymer at a temperature greater than 50° C. to dissociate the crosslinking bonds of the reversibly-crosslinked polymer.

19. The method according to claim 18, wherein reprocessing occurs at a temperature greater than 150° C.

20. A reprocessed polymer produced by the process according to claim 15.

21. (canceled)

22. The method according to claim 15, wherein the crosslinker is in the form of an ensemble of crosslinker molecules, each crosslinker molecule in the ensemble being a compound represented by Formula (I), (II), (III), (IV), or (V), and wherein for at least 90% of the crosslinkers molecules in the ensemble, n is equal to 2.

23. (canceled)

24. The method according to claim 15, wherein the crosslinker further comprises, in addition to at least one crosslinker represented by Formula (I), (II), (III), (IV), or (V), a crosslinker represented by Formula (VI):
E₁-(R²¹)(R²²)N—Sₙ—N(R²³)(R²⁴)-E₂ (VI),
wherein each of E₁ and E₂ is independently a (meth)acrylate, (meth)acrylamide, a C₁-C₂₀ alkylene, a C₂-C₂₀ cycloalkylene, a divalent form of C₂-C₂₀ alkene, a divalent form of C₂-C₂₀ alkyne, an arylene, or combinations thereof, each optionally substituted by one or more alkyl, alkenyl, hydroxyl, or halogen atoms,
wherein the crosslinker represented by Formula (VI) is in the form of an ensemble of crosslinker molecules, and
wherein for at least 90% of the crosslinkers molecules represented by Formula (VI) in the ensemble, n is equal to 2.

25. (canceled)

26. The method according to claim 15, wherein the crosslinker comprises at least one member selected from the group consisting of allyl disulfide, diallyl disulfide, allyl trisulfide, diallyl trisulfide, bis(2-methacryloyl)oxyethyl disulfide (DSDMA), diallyl 2,2′-disulfanediyldibenzoate, diallyl 2,2′-disulfanediyldiacetate, diallyl 4,4′-disulfanediyldibutyrate, diallyl 3,3′-disulfanediyldipropionate, disulfanediylbis(3,1-phenylene) diacrylate, disulfanediylbis(ethane-2,1-diyl) diacrylate, N,N′-(disulfanediylbis(2,1-phenylene))diacrylamide, N,N′-(disulfanediylbis(4,1-phenylene))diacrylamide, N,N′-Bis(acryloyl)cystamine (BAC), and ((((disulfanediylbis(4,1-phenylene))bis(azanediyl))bis(carbonyl))bis(azanediyl))bis(ethane-2,1-diyl)bis(2-methylacrylate) (4MUPD).

27-29. (canceled)

30. The method according to claim 15, wherein the starting polymer is a polymer comprising reacted units of ethylene, an α-olefin, a vinyl monomer, or a combination thereof.

31. The method according to claim 15, wherein
the α-olefin comprises propylene, 1-butylene, 1-pentene, 1-hexene, 1-heptene, 1-octane, 1-nonene, 1-decene, or a combination thereof; and
the vinyl monomer comprises a vinyl acetate compound, an acrylate compound, a vinyl ester compound, a styrenic compound, a diene compound, a vinyl halide, a vinyl nitrile, a vinyl silane.

32. The method according to claim 15, wherein the free-radical generator comprises heat, a small-molecule free radical generator compound, or both.

33. The method according to claim 15, wherein the free-radical generator comprises at least one small-molecule free radical generator compound selected from the group consisting of a peroxide, an azo compound, a peracetate compound, and a nitroxide.

34-36. (canceled)

37. The method according to claim 15, wherein said reacting is carried out at a temperature of at least 70° C.

38-39. (canceled)

40. The method according to claim 15, wherein the reactive extrusion process is carried out at a temperature at or above the softening temperature of the starting polymer.

41-42. (canceled)
